(19) United States
(12) Patent Application Publication
(10) Pub. No.: US 2012/0010870 A1
(43) Pub. Date: Jan. 12, 2012

(54) ELECTRONIC DICTIONARY AND DICTIONARY WRITING SYSTEM

(76) Inventors: Vladimir Selegey, Moscow (RU); Anna Rylova, Moscow (RU)

(21) Appl. No.: 13/178,932

(22) Filed: Jul. 8, 2011

Related U.S. Application Data
(60) Provisional application No. 61/363,191, filed on Jul. 9, 2010.

(51) Int. Cl. G06F 17/28; G06F 17/21

(52) U.S. Cl. 704/3; 704/10; 704/2; 704/E11.001

(57) ABSTRACT

Described herein is a computer implemented method for creating content for electronic dictionaries. An exemplary system includes a user interface, entry filtration system, and interface tools for dictionary entry comparison, entry merge, and visual markup of changes. Many dictionaries may be accessed and used in one user interface window. A user may enter a grammatical, syntactic and semantic markup which may be helpful when the user translates a word or a text directly from an electronic document. An appropriate lexical meaning may be selected during translation from among several lexical meanings depending on a grammatical, syntactic and/or semantic context of a word or phrase.

### CROSS-REFERENCE TO RELATED APPLICATIONS

For purposes of the USPTO extra-statutory requirements, the present application constitutes a continuation-in-part of U.S. Patent Application No. 61/363,191 that was filed on 9 Jul. 2010, which is currently co-pending, or is an application of which a currently co-pending application is entitled to the benefit of the filing date.

The United States Patent Office (USPTO) has published a notice effectively stating that the USPTO's computer programs require that patent applicants reference both a serial number and indicate whether an application is a continuation or continuation-in-part. Stephen G. Kunin, Benefit of Prior-Filed Application, USPTO Official Gazette 18 Mar. 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND OF THE INVENTION

1. Field

The present disclosure is directed towards creating content for electronic and paper dictionaries, and compiling dictionaries, glossaries, encyclopedias and other types of reference materials.

2. Related Art

A dictionary writing system (DWS) is intended for creating content for electronic and paper dictionaries, compiling dictionaries, glossaries, encyclopedias, and other types of reference materials. It may be a part of an electronic dictionaries platform, which, apart from the DWS, may include a number of content conversion and dictionary publishing tools, enabling the publication of dictionaries in electronic format, on paper, and online. Online dictionaries can be accessed via a dictionary server or other device or service over the Internet.

One need of a typical dictionary user is to find an appropriate translation for a word in a text (text reception) or an appropriate translation of a word from one language to another. When a user sees some new or unknown word in a text, he typically tries to look it up in a dictionary and find an appropriate translation from a dictionary entry with many translations, examples, synonyms and other information that is usually included in dictionaries. One of the most challenging task for a dictionary producer is to help the dictionary reader find a good translation and other relevant information about the word. This task can be done well if a lexicographer puts relevant markup with a dictionary entry. This task is also done well when an electronic dictionary processes this markup and provides a good user interface that shows a result that includes this processing to the dictionary user.

### SUMMARY

Described herein are a computer implemented method and system for creating content for electronic dictionaries. The system comprises a user-friendly interface and entry filtration system. It also includes interface tools for dictionary comparison and merge, and visual markup of changes. The system has a possibility of working with many dictionaries in one window.

Another feature of the system is to provide a mechanism to regularly enter a grammatical, syntactic and semantic markup which may be used when the user translates a word or a text directly from an electronic document on a computer or any electronic device. In such case, the system may select an appropriate lexical meaning for translating among other lexical meanings depending on a grammatical context, syntactic context, semantic context, or a combination of contexts.

### BRIEF DESCRIPTION OF THE DRAWINGS

FIG. 1 shows an example of the entry “file” in an electronic dictionary.

FIG. 1A shows an example of a user interface element displaying an appropriate translation from a dictionary entry of a word selected by a user on a screen of an electronic device, in accordance with an exemplary embodiment or implementation of the present disclosure.

FIG. 2 shows a flowchart of operations performed by a dictionary software in accordance with an embodiment or implementation of the present disclosure.

FIG. 3 shows exemplary hardware for implementing a system and performing a method according to the present disclosure.

### DETAILED DESCRIPTION

An electronic dictionary software assists a user in translating and analyzing text. In an exemplary implementation, a user interface of such dictionary software includes a pop-up translation tool. When a user meets an unknown word in a text, the user can point to the word with a mouse cursor (or touch a screen with a finger). A pop-up window appears with a short translation of the word taken from an electronic dictionary. If the user clicks on a translation in the pop-up window, he sees a full dictionary entry. A short translation function can help a user save time while reading and translating texts.

A user may use a special markup through a novel dictionary writing system (DWS), in accordance with an embodiment of the present disclosure. The DWS has an appropriate functionality through a dictionary software. The dictionary software opens up new possibilities in creating content for electronic and paper dictionaries and in finding appropriate translations.

DWS features are intended to facilitate dictionary creation and compilation and to automate typical lexicographic chores. The DWS features have been designed based on careful study of practical needs of lexicographers and editors and based on experience in creating dictionaries and encyclopedias. These features include, for example, the following:
managing the structure of entries and automatic renumbering of entry elements, such as senses and homonyms;
automatic cross-references update; and
spell-checking the text of the entries and validating their structure.

Additionally, the DWS has other features, which allow a lexicographer to work with the system without any special computer tools and knowledge. Some of these other features of the system include, for example, the following:
embedded in the DWS interface, a user-friendly entry filtration system that allows a lexicographer to use tick boxes for filtration (filtration window tabs) instead of using a special query language;
an interface to facilitate dictionary comparison and merging visual markup of changes where any two versions of a dictionary entry are compared and it is shown what was added (such as showing by a highlight in green), deleted (such as showing by a highlight in red) and changed (such as showing by a highlight blue); and
a user interface that allows a user to edit dictionary entries where the entries come from two or more dictionaries and are shown in one window.

The DWS allows entry of a grammatical, syntactic and semantic markup when the user translates a word or a text directly from an electronic document. In such case the system may select an appropriate lexical meaning for translating among others depending on a grammatical context, syntactic context, semantic context, or a combination of contexts.

### Filtering

When working on a dictionary, a lexicographer or the head lexicographer often needs to examine a selection of entries that meet certain criteria. For example, one may wish to see a list of all phrasal verbs in the dictionary, or all entries that contain an idiom with a certain word, or all entries that contain a certain number of senses, or the entries marked by a lexicographer for future revision. The DWS as described herein provides users with a filtering feature which enables them to retrieve data without the use of a specialized query language. Instead, they can simply select required filtering criteria in a filtering dialog box. The entries obtained in this manner can then be saved, either as a batch or as a separate dictionary, and a user may be assigned to edit them.

### Multiuser Work

Based on a client/server architecture, the DWS supports multi-user concurrent access and is suitable for large dictionary-making projects. The lexicographers may be physically located anywhere in the world and work on the same dictionary together. The entries that are being edited or have been assigned to specific lexicographers are marked accordingly in the word list, which is visible to the entire team. The lexicographers and editors may work on a dictionary in an online mode, in which case all new texts are immediately sent to a central server, or in an offline mode, in which case all texts are created and stored locally and then uploaded to the central server.

The DWS logs all changes made to dictionary entries. Users of the system can easily find out which lexicographers worked on which entries during a given period of time, or refine the search criteria to see which entries have been changed, deleted or added, or in which entries to a headword have been edited, or which entries have been restored to their earlier versions.

Version history is available for each entry: the segments of an entry that have been edited, deleted o added are highlighted in different colors. It is also possible to roll-back an entry to an earlier version. It is possible to view the current version of the dictionary at any moment.

### Workflow

A status can be specified for any entry. In a preferred implementation, each entry is given or required to have a status. Each dictionary has its own set of statuses, which indicate the progress of the work. For example, a each entry in a dictionary has one of a variety of statuses: (1) “entry has been created by lexicographer”, (2) “entry has been reviewed by editor”, (3) “entry has been proofread”, and (4) “entry is ready to be published”. Through a feature or function of a user interface, it is possible to find out how many entries have a certain status. For example, if 95% of entries are “ready to be published”, this means that the dictionary can soon be released on paper, on CD-ROM or other electronic media, or made available online.

### Consistency of Content

Preferentially, a user of electronic dictionaries prefers to access several different dictionaries simultaneously for any given word or expression. The several dictionaries may be selected from universal, special, explanatory, foreign language dictionaries and other dictionaries. In much the same way, a lexicographer during creation of a dictionary entry would like to see corresponding entries from many dictionaries. For each dictionary, its overall structure and the structure of its entries may be specified. The structure of entries generally determines the order of entry sections and their “nesting”. In one exemplary implementation of the user interface, a user accesses modifiable fields in a toolbar. The toolbar displays only those fields which are modifiable. A cursor may indicate that these fields are modifiable. Only entries that are allowed are selectable. Thus, a lexicographer only needs to click on an allowed field on the toolbar, and the user interface facilitates entry of data without a need to open and scroll large lists of unusable entries.

It is also possible to specify a list of labels to be used in a dictionary. The system either validates a label as it is typed by a lexicographer, or prompts the lexicographer to select an appropriate label from a general list. Editing a label or its wording in the general list changes this label throughout the dictionary.

Another feature of the DWS is an automatic cross-reference update. If any word sense is moved in an entry (for example, from position 1a to position 3b) all the references to this entry will stay valid and any numbering in a reference name will be automatically updated. If the entry or a word sense is deleted, the system issues a warning and shows all entries that are linked with the deleted entry. A lexicographer can delete the references manually or automatically.

### Merging and Comparing Dictionaries

When working on dictionaries for the same language combination (e.g, Russian-English), their word lists may be compared. The comparison tool has an intuitive visual interface. A lexicographer may expand a general dictionary by comparing it against specialized dictionaries. The result of such comparison will be a selection of entries not found in the general dictionary, which can either be edited and then added into the general dictionary or added into the general dictionary in its entirety. For each new entry thus obtained, its original source can be indicated.

The DWS allows merging of dictionaries and merging of selections of dictionary entries. A user can view several dictionaries or selections of entries in one window or user interface element. For example, a user sees a combined word list with an indicator of the source dictionary or selection of entries indicated next to each item. Using this viewing mode, a lexicographer can not only add new entries to their dictionaries but also create and edit entries for several dictionaries simultaneously. For example, a lexicographer can work on a comprehensive and pocket edition at the same time.

### Publishing Dictionaries

Dictionaries created with the DWS can be easily published on paper, in an electronic medium or on the Web. It only takes a few minutes to publish a dictionary electronically. All dictionary data are exported into a format that can be read by a dictionary viewer.

If a dictionary is to be printed on paper, it is exported from the DWS into a publishing system via a final or intermediate file format. For example, a dictionary may be exported to an XML, RTF or DOCX file format. To publish a dictionary on the Web, a dictionary server may be used. The dictionary is exported to a format that is accessible by the dictionary server. A Web service may enable searches across various types of reference sources, including dictionaries and encyclopedias. A dictionary server can be accessed over the Internet or other network.

### Syntactic and Semantic Markup

Some electronic dictionaries may have a very large number of entries and they may contain a lot of different homonyms and lexical meanings Consequently, access to the whole entry content, selection of an appropriate meaning, and translation may require a considerable period of computational and actual time when a user translates a word from a text string. If entries of an electronic dictionary are provided by grammatical, syntactic and semantic markup, a user receives not all variants of translation, but only those variants of translation which correspond to the subject matter and the context. Access or latency time is greatly reduced. At the same time, each lexical meaning of a particular dictionary entry is provided by a syntactic model, a semantic model or a combination of models.

For example, a lexicographer may refer or associate headwords and definitions to definite semantic fields and describe their basic syntactic patterns and contexts. The availability of such markup makes it possible to examine formal parameters of the context during analysis to get an appropriate translation of a word in a text. Thereby an electronic dictionary acquires the means to analyze context, basic semantics and grammar patterns for a particular word or phrase, and gives a user only one and most likely definition from a big dictionary entry when a user seeks a definition for the particular word or phrase, and this likely is the exact definition the user is looking for. In one embodiment of the invention, the context includes a current sentence. In another embodiment of the invention, the context includes more then one sentence, for example, a paragraph.

For example, the word “file” has several homonyms and several lexical meanings, and depending on a context, “file” may be translated as different parts of speech, and each part of speech may have several absolutely different meanings. The different meanings also likely have different syntactical models of usage. For description of such models of lexical meanings in the dictionary, the corresponding markup is used.

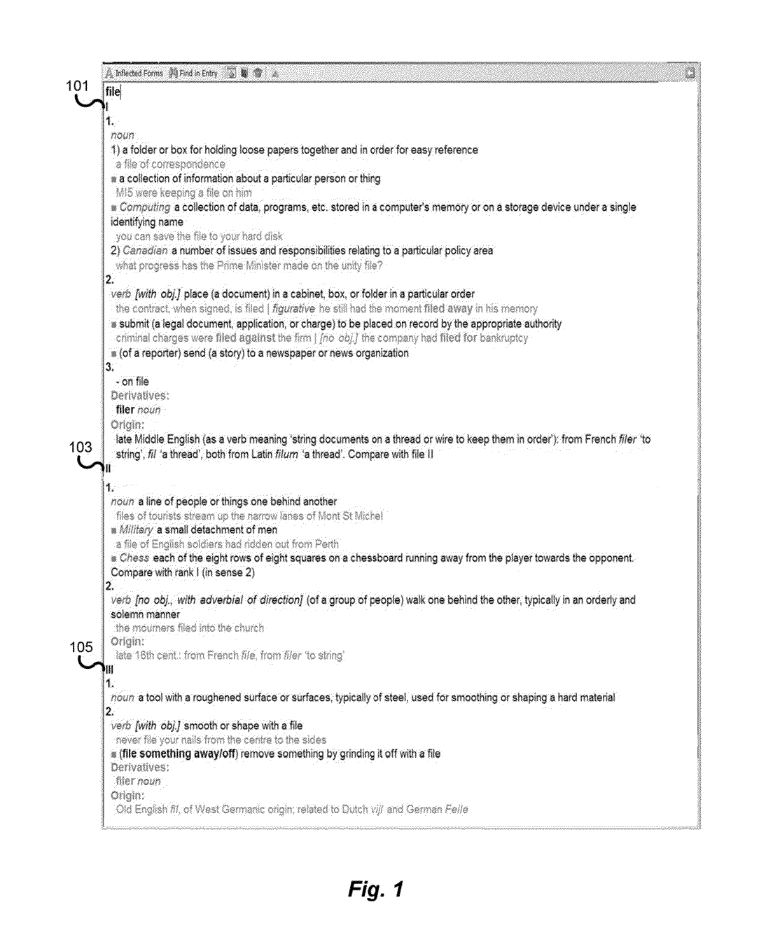

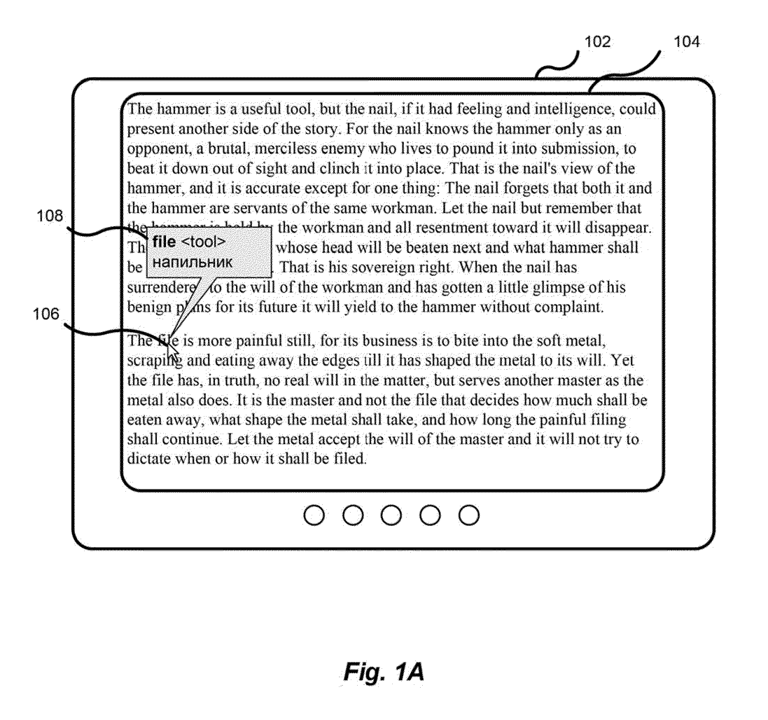

FIG. 1 shows an example of the entry “file” in an electronic dictionary. With reference to FIG. 1, the entry has three different homonyms which are designated as Roman numerals—I (101), II (103) and III (105), where, for example, the first homonym has three grammatical values including a noun (1.) and a verb (2.), and several lexical meanings—1) a folder or box; 2) a collection of information; 3) a collection of data, programs, etc. stored in a computer's memory. The meanings 1) and 2) may relate, for example, to topics “office work”, “records management”, “workflow”, the 3) meaning—to “computing”. The other meanings may have a specific meaning, for example, “Canadian” for “a number of issues and responsibilities relating to a particular policy area”.

The second homonym II “a line of people or things one behind another” may be general, but if the translated text contains terms related to “military” or “chess”, these meanings should be selected. The third homonym III is very specific, and if the translated text contains terms related to “metalwork”, “tools”, “instrument”, this meaning should be selected.

The presence of a preposition, article, particle or other specific word before or after the translated word may govern the selection of the part of speech, but “to” may be a preposition, but may indicate an Infinitive of a verb. In such an indistinct case, other indications may be used.

FIG. 1A shows an example of displaying an appropriate translation from a dictionary entry of a word selected by a user on a screen 104 of an electronic device 102, in accordance with one embodiment of the present disclosure. The user may select the word, for example, by means of a mouse cursor 106 or by a touch to the electronic device 102 or screen 104. The system displays a Russian translation “ [symbol] ” (=a tool with a roughened surface or surfaces) from an English-Russian dictionary because the lexical meaning is most appropriate for the context, for example, in a balloon 108 or in a tooltip.

In one embodiment of the present invention, the system may select an appropriate lexical meaning for translating among others depending on grammatical, syntactic and semantic context that may include one or more sentence of the translated text.

In another embodiment, each lexical meaning may be connected to a lexical-semantic dictionary. Each lexical meaning in the lexical-semantic dictionary has its surface (syntactical) model which includes one or more syntforms, as well as, idioms and word combinations with the lexical meaning Syntforms may be considered as “patterns” or “frames” of usage. Every syntform may include one or more surface slots with their linear order description, one or more grammatical values expressed as a set of grammatical characteristics (grammemes), and one or more semantic restrictions on surface slot fillers. Semantic restrictions on a surface slot filler are a set of semantic classes, whose objects can fill this surface slot.

The semantic classes are semantic notions (semantic entities) and named semantic classes are arranged into one or more semantic hierarchies—hierarchical parent-child relationships—similar to a tree. In general, a child semantic class inherits most properties of its direct parent and all ancestral semantic classes. For example, semantic class SUBSTANCE is a child of semantic class ENTITY and the parent of semantic classes GAS, LIQUID, METAL, WOOD_MATERIAL, etc.

The semantic hierarchy is a universal, language-independent structure, and the semantic classes may include lexical meanings of various languages, which have some common semantic properties and may be attributed to the same notion, phenomenon, entity, situation, event, object type, property, action, and so on. Semantic classes may include many lexical meanings of the same language, which differ in some aspects and which are expressed by means of distinguishing semantic characteristics (semantemes). Semantemes express various properties of objects, conditions and processes that may be described in the language-independent semantic structure and expressed in natural languages grammatically and syntactically (for example, number, gender, aspect and tense of actions, degree of definiteness, modality, etc.), or lexically. So, lexical meanings are provided with distinguishing semantemes.

Each semantic class in the semantic hierarchy is supplied with a deep model. The deep model of the semantic class is a set of the deep slots, which reflect the semantic roles in various sentences. The deep slots express semantic relationships, including, for example, “agent”, “addressee”, “instrument”, “quantity”, etc. A child semantic class inherits and adjusts the deep model of its direct parent semantic class.

The system of semantemes includes language-independent semantic attributes which express not only semantic characteristics but also stylistic, pragmatic and communicative characteristics. Some semantemes can be used to express an atomic meaning which finds a regular grammatical and/or lexical expression in a language. For example, the semantemes may describe specific properties of objects (for example, “being flat” or “being liquid”) and are used in the descriptions as restriction for deep slot fillers (for example, for the verbs “face (with)” and “flood”, respectively). The other semantemes express the differentiating properties of objects within a single semantic class, for example, in the semantic class HAIRDRESSER the semanteme <<RelatedToMen>> is assigned to the lexical meaning “barber”, unlike other lexical meanings which also belong to this class, such as “hairdresser”, “hairstylist”, etc.

Lexical meanings may be provided by a pragmatic description which allows the system to assign a corresponding theme, style or genre to texts and objects of the semantic hierarchy. For example, “Economic Policy”, “Foreign Policy”, “Justice”, “Legislation”, “Trade”, “Finance”, etc. Pragmatic properties can also be expressed by semantemes. For example, pragmatic properties may be taken into consideration during the translation words in context of neighboring and surrounding words and sentences.

When a lexicographer is creating a dictionary entry, he may directly link each or some lexical meanings with a corresponding lexical meaning in the semantic hierarchy. The connection may not be readily visible to a user of the electronic dictionary, but the lexical meaning in the electronic dictionary will inherit all syntactic and semantic models and descriptions of corresponding lexical meaning in the semantic hierarchy.

So when the electronic dictionary software tries to find an appropriate lexical meaning for the current word to translate it into another natural language, the system, at first, finds its one or more morphological lemma, and when the system finds more than one lexical meaning corresponding to the lemma, the system analyzes the syntactic, semantic and pragmatic context which may include one or more neighboring and surrounding words or sentences. Then, the system may select an appropriate lexical meaning from the dictionary on the basis of such a context analysis.

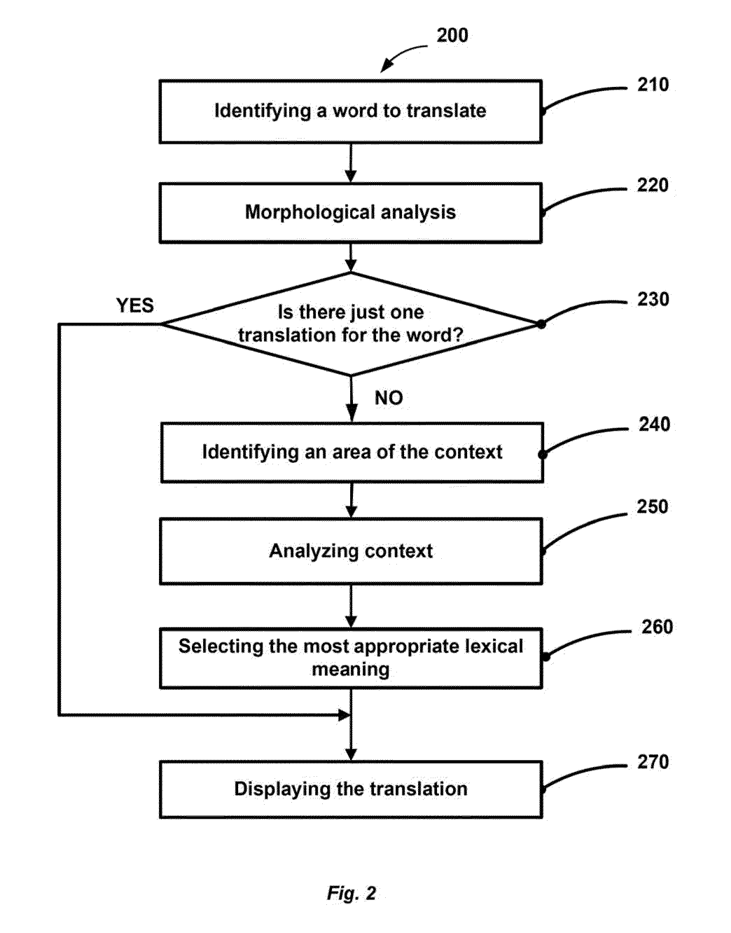

FIG. 2 shows a flowchart of operations performed by a dictionary software in accordance with an embodiment of the present disclosure. With reference to FIG. 2, and for example, the “proximity” of some lexical meanings in the semantic hierarchy may be taken into account when the appropriate lexical meaning must be selected on the basis of analyzing the pragmatic and semantic context during translating. In other words, if the words “file” and “hammer”, which have the common parent—the semantic class INSTRUMENT, are occurred in some surrounding context, then the meaning “a tool with a roughened surface” should be selected for translating. Otherwise, if the words, for example, “save”, “folder”, “open” etc., which have the common parent—the semantic class COMPUTER, are occurred in some surrounding context with the “file”, then the meaning “a data, programs, etc. stored in a computer's memory or on a storage device under a single identifying name” should be selected for translating.

Of course, the correspondence of neighboring and surrounding words to the patterns described in syntforms also may be taken into account during lexical meaning selection.

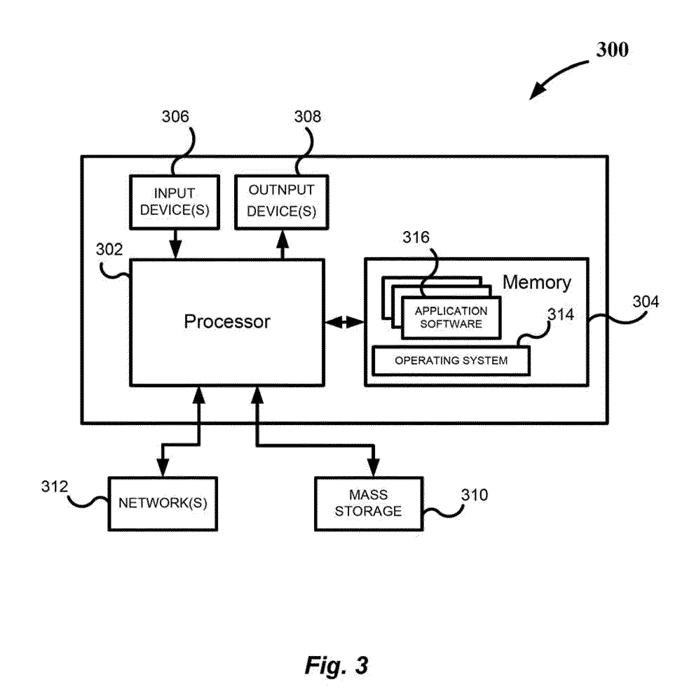

FIG. 3 of the drawings shows hardware 300 that may be used to implement a user electronic device 102 in accordance with one embodiment of the invention in order to translate a word or word combination and to display one or more translations to a user. Referring to FIG. 3, a hardware 300 typically includes at least one processor 302 coupled to a memory 304. The processor 302 may represent one or more processors (e.g. microprocessors), and the memory 304 may represent random access memory (RAM) devices comprising a main storage of the hardware 300, as well as any supplemental levels of memory, e.g., cache memories, non-volatile or back-up memories (e.g. programmable or flash memories), read-only memories, etc. In addition, the memory 304 may be considered to include memory storage physically located elsewhere in the hardware 300, e.g. any cache memory in the processor 302 as well as any storage capacity used as a virtual memory, e.g., as stored on a mass storage device 310.

The hardware 300 also typically receives a number of inputs and outputs for communicating information externally. For interfacing with a user or operator, the hardware 300 may include one or more user input devices 306 (e.g., a keyboard, a mouse, imaging device, scanner, etc.) and a one or more output devices 308 (e.g., a Liquid Crystal Display (LCD) panel, a sound playback device (speaker)). To embody the present invention, the hardware 300 must include at least one display or interactive element (for example, a touch screen), an interactive whiteboard or any other device which allows the user to interact with a computer by touching areas on the screen.

For additional storage, the hardware 300 may also include one or more mass storage devices 310, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 300 may include an interface with one or more networks 312 (e.g., a local area network (LAN), a wide area network (WAN), a wireless network, and/or the Internet among others) to permit the communication of information with other computers coupled to the networks. It should be appreciated that the hardware 300 typically includes suitable analog and/or digital interfaces between the processor 302 and each of the components 304, 306, 308, and 312 as is well known in the art.

The hardware 300 operates under the control of an operating system 314, and executes various computer software applications, components, programs, objects, modules, etc. to implement the techniques described above. In particular, the computer software applications will include the client dictionary application, in the case of the client user device 102. Moreover, various applications, components, programs, objects, etc., collectively indicated by reference 316 in FIG. 3, may also execute on one or more processors in another computer coupled to the hardware 300 via a network 312, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. Another type of distribution may be implemented as Internet downloads.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

We claim:

1. A system for manipulating content of an electronic dictionary, the system comprising:
an interface capable of receiving a grammatical markup, a syntactic markup or a semantic markup of a portion of text from an electronic document; and
a storing component that stores the markup with a corresponding segment of a dictionary entry corresponding to the portion of text, wherein the storing component is accessible across a network by a plurality of users.

2. The system of claim 1, wherein the system further comprises a markup processor that is capable of processing the markup and provides a reduced number of dictionary definitions based at least in part upon the markup.

3. The system of claim 2, wherein the system further comprises a user interface that displays the reduced number of definitions.

4. The system of claim 2, wherein the system examine formal parameters of the context during analysis to get an appropriate translation of a word in a text.

5. The system of claim 1, wherein the system further comprises a merge interface that is configured to facilitate a dictionary entry comparison and dictionary entry merge, wherein the merge interface is configured to display a markup of prospective changes before any merge is actually performed.

6. The system of claim 5, wherein the merge interface is capable of displaying the markup for merging of dictionary entries from a plurality of dictionaries.

7. The system of claim 1, wherein the system further comprises a user tracking component that is configured and capable of tracking manipulations of content by respective users of the system.

8. A method of providing a translation of a word or phrase (an entity) in a text from a first language to a second language, the method comprising:
performing a morphological analysis of entities in an electronic dictionary;
identifying the entity in the text to translate;
performing a morphological analysis of the entity in the text;
matching the entity in the text to one or more of the entities in the electronic dictionary;
determining whether there is more than one translation meaning of the one or more matched entities based on the morphological analysis of entities in the electronic dictionary;
identifying an area of context of the entity in the text when there is more than one lexical translation meaning of the one or more matched entities;
determining a most probable lexical translation meaning of the one or more matched entities from the area of context of the entity in the text; and
communicating the most probable lexical translation meaning of the entity.

9. The method of claim 8 wherein communicating the most probable lexical translation meaning of the one or more matched entities comprises displaying the most probable lexical translation meaning of the one or more matched entities.

10. The method of claim 8 wherein communicating the most probable lexical translation meaning of the one or more matched entities comprises displaying a pop-up user interface element, and wherein the pop-up user interface element displays a shortened lexical translation meaning of the one or more matched entities.

11. The method of claim 8 wherein determining the most probable lexical translation meaning of the one or more matched entities from the area of context of the entity in the text comprises searching across entries from two or more dictionaries.

12. The method of claim 10 wherein the displaying the pop-up user interface element includes displaying one or more shortened lexical translation meanings in addition to the most probable lexical translation meaning of the one or more matched entities, the one or more shortened lexical translation meanings being taken from two or more dictionaries.

13. The method of claim 8 wherein each lexical translation meaning is connected to an entry in a lexical-semantic dictionary; wherein each lexical translation meaning in the lexical-semantic dictionary is associated with a corresponding syntactical model which includes one or more syntforms; and wherein each syntform includes (1) one or more surface slots with a linear order description, (2) one or more grammatical values expressed as a set of grammatical characteristics (grammemes), and (3) one or more semantic restrictions on surface slot fillers; and wherein determining the most probable lexical translation meaning of the entity includes analysis of neighboring words in view of one or more patterns described in syntforms.

14. A computer program product for providing a translation of a word or phrase (an entity) in a text from a first language to a second language, wherein the computer program product comprises at least one non-transitory computer-readable storage medium having computer-readable program code portions stored therein, the computer-readable program code portions comprising:
a first executable portion for performing a morphological analysis of entities in an electronic dictionary;
a second executable portion for identifying the entity in the text to translate;
a third executable portion for performing a morphological analysis of the entity in the text;
a fourth executable portion for determining whether there is more than one translation meaning of the entity in the text based at least in part on the morphological analysis of entities in an electronic dictionary or at least in part on the morphological analysis of the entity in the text;
a fifth executable portion for identifying an area of context of the entity in the text when there is more than one lexical translation meaning of the entity in the text;
a sixth executable portion for determining a most probable lexical translation meaning of the entity from the area of context of the entity in the text; and
a seventh executable portion for communicating the most probable lexical translation meaning of the entity in the text.

15. The computer program product of claim 14 wherein communicating the most probable lexical translation meaning of the entity in the text comprises displaying the most probable lexical translation meaning of the entity in the text.

16. The computer program product of claim 14 wherein communicating the most probable lexical translation meaning of the entity in the text comprises displaying a pop-up user interface element, and wherein the pop-up user interface element displays a shortened lexical translation meaning of the entity in the text.

17. The computer program product of claim 14 wherein determining the most probable lexical translation meaning of the entity from the area of context of the entity in the text comprises searching across entries from two or more dictionaries.

18. The computer program product of claim 16 wherein the displaying the pop-up user interface element includes displaying one or more shortened lexical translation meanings in addition to the most probable lexical translation meaning of the entity in the text, the one or more shortened lexical translation meanings being taken from two or more dictionaries.

19. The computer program product of claim 14 wherein each lexical translation meaning is connected to an entry in a lexical-semantic dictionary; wherein each lexical translation meaning in the lexical-semantic dictionary is associated with a corresponding syntactical model which includes one or more syntforms; and wherein each syntform includes (1) one or more surface slots with a linear order description, (2) one or more grammatical values expressed as a set of grammatical characteristics (grammemes), and (3) one or more semantic restrictions on surface slot fillers; and wherein determining the most probable lexical translation meaning of the entity includes analysis of neighboring words in view of one or more patterns described in syntforms.
